(19) United States
(12) Patent Application Publication
(10) Pub. No.: US 2007/0003178 A1
(43) Pub. Date: Jan. 4, 2007

(54) Cylindrical roller bearing and retainer for cylindrical roller bearing

(76) Inventor: Mineo Koyama, Kuwana-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/453,984

(22) Filed: Jun. 16, 2006

(30) Foreign Application Priority Data
Jun. 30, 2005 (JP) 2005-191121

(51) Int. Cl. F16C 19/00; F16C 33/54

(52) U.S. Cl. 384/470; 384/573

(57) ABSTRACT

To supply a lubricating oil to axial centers of cylindrical rollers where lubrication is the most difficult. A retainer for a cylindrical roller bearing comprises a pair of annular portions and a plurality of column portions for connecting the annular portions to each other, and pockets for accommodating the cylindrical rollers being formed in spaces surrounded by the opposed annular portions and adjoining column portions. In this retainer, lubricant trap portions are formed in guide surfaces of the column portions for guiding rolling contact surfaces of the cylindrical rollers opposed thereto in the circumferential direction of the pockets, the lubricant trap portions gradually decreasing in axial width as extending radially outward in axial centers. An example of the shape of gradually decreasing in width as extending radially outward in the axial center is a generally triangular shape having an apex radially outward.

### BACKGROUND OF THE INVENTION

1. Field of the Invention

The invention relates to a cylindrical roller bearing and a retainer for a cylindrical roller bearing such as a single-row cylindrical roller bearing which is widely used in various industrial machines including spindle units of machining tools, in automobile transmissions, and the like where high-speed rotation and high precision are required.

2. Description of the Related Art

For example, spindle units of such machining tools as a lathe and a machining center are often operated to rotate at high speed for the sake of improving work machining efficiency, precision, and the like. In particular, with recent trends toward sophisticated functions and higher efficiency, bearings for use in the spindle units need to deal with additional speedup and longer life. In view of these requests for higher speed and longer life, there has been proposed a single-row cylindrical roller bearing having a retainer that is shaped in order to suppress heat generation during high-speed rotation and improve strength for the sake of stable performance during high-speed rotation (for example, see Japanese Patent Laid-Open Publications Nos. 2003-278746 and 2004-316757).

For example, as shown in FIG. 9, this single-row cylindrical roller bearing is primarily composed of: an inner ring 1 having a raceway surface 1a on its outer periphery; an outer ring 2 having a raceway surface 2a on its inner periphery; a plurality of cylindrical rollers 3 rotatably arranged between the raceway surface 1a of the inner ring 1 and the raceway surface 2a of the outer ring 2; and a retainer 4 for retaining those cylindrical rollers 3 at predetermined intervals in the circumferential direction. Flange portions 5 for restraining axial movement of the cylindrical rollers 3 are formed on both sides of the outer periphery of the inner ring 1.

The guide systems of the foregoing retainer include an outer-race or inner-race guide system in which the retainer is guided by the inner periphery of the outer ring or the outer periphery of the inner ring, and a roller guide system in which it is guided by the rollers. The retainer 4 of the roller guide system comprises a pair of annular portions 4a opposed at a predetermined interval in the axial direction, and a plurality of column portions 4b for connecting the annular portions 4a to each other. Window-shaped pockets 6 for accommodating the cylindrical rollers 3 are formed in the spaces surrounded by the opposed annular portions 4a and adjoining column portions 4b.

Now, the foregoing single-row cylindrical roller bearing of inner-race flange type will be described with an example of inner-ring rotation. In the case of a retainer of the roller guide system, the cylindrical rollers rotate on their axes along with the rotation of the inner ring, and also revolve around to push guide surfaces of the pockets, thereby rotating the retainer. In cross section, the guide surfaces of the pockets are shaped like an arc having a radius of curvature somewhat greater than that of the cylindrical rollers, and the cylindrical rollers are guided as if accommodated in the arc-shaped guide surfaces of these pockets.

Consequently, a lubricating oil taken in by the rotation forms an oil film between the cylindrical rollers and the guide surfaces of the pockets. If the lubricating oil is excessive, the oil film increases in viscosity resistance, leading to heat generation. If the lubricating oil is insufficient, the cylindrical rollers rotating at high speed and the guide surfaces of the pockets run out of oil films since they are in slide contact with each other. This leads to insufficient lubrication of the cylindrical rollers or abrasion of the guide surfaces of the pockets.

If the bearing is operated at high speed in a spindle unit of a machining tool or the like, the viscosity resistance of the oil film increases with a rise in the bearing temperature. This cylindrical roller bearing for use in various industrial machines including spindle units of machining tools is ever increasing in speed and in precision. Reducing the rise of the bearing temperature leads to speedup of the spindle and a reduction of precision deterioration.

In the meantime, there has been proposed a retainer in which recesses for trapping the lubricating oil are formed in the guide surfaces of the pockets in order to avoid insufficient lubrication and abrasion of the guide surfaces of the pockets ascribable to short of oil films (for example, see Japanese Patent Laid-Open Publication No. 2002-147464).

Since this retainer has axially oblong recesses as the lubricant trap portions, the lubricating oil once trapped flows out from arbitrary positions of the recesses to the guide surfaces of the pockets. In particular, the lubricating oil flowing out from both axial ends of the recesses are expelled to both sides of the cylindrical rollers, whereby the lubricating oil supplied from the recesses, or lubricant trap portions, are dispersed.

In typical cylindrical roller bearings, the axial centers of the cylindrical rollers are cylindrical surfaces which are always in contact with the raceway surfaces. Both ends of the cylindrical rollers are provided with crowning portions, shrinking by several micrometers or so toward the ends as compared to the centers. The centers of the cylindrical rollers make line contact with the raceway surface of the inner ring and the raceway surface of the outer ring, and are difficult for the lubricating oil to get into.

### SUMMARY OF THE INVENTION

An object of the present invention is to supply a lubricating oil to the axial centers of the cylindrical rollers easily where lubrication is the most difficult.

The present invention provides a retainer for a cylindrical roller bearing, comprising a pair of annular portions and a plurality of column portions for connecting the annular portions to each other, pockets for accommodating cylindrical rollers being formed in spaces surrounded by the opposed annular portions and adjoining column portions, wherein lubricant trap portions are formed in guide surfaces of the column portions for guiding rolling contact surfaces of the cylindrical rollers opposed thereto in the circumferential direction of the pockets, the lubricant trap portions gradually decreasing in axial width as extending radially outward in axial centers. The present invention is applicable to a retainer of a cylindrical roller bearing which comprises: an inner ring having a raceway surface on its outer periphery; an outer ring having a raceway surface on its inner periphery; a plurality of cylindrical rollers rotatably interposed between the raceway surface of the inner ring and the raceway surface of the outer ring; and a retainer for retaining the cylindrical rollers at predetermined intervals in a circumferential direction.

According to the present invention, the lubricating oil held in or supplied to the pockets of the retainer is taken into the lubricant trap portions formed in the guide surfaces of the pockets, and moves radially outward due to a centrifugal force during operation. Here, since the lubricant trap portions described above are shaped so that they gradually decrease in axial width as extending radially outward in the axial centers, the lubricating oil taken into the lubricant trap portions is collected to the axial centers while moving radially outward, and is easily supplied to the axial centers of the cylindrical rollers where lubrication is the most difficult.

This makes it possible to reduce the amount of the lubricating oil to be supplied, and supply the small amount of lubricating oil to the centers of the rolling contact surfaces of the cylindrical rollers effectively. Consequently, it is possible to lower the viscosity resistance of the oil film, owing to the reduced amount of the lubricating oil, when operating the cylindrical roller bearing at high speed in a spindle unit of a machining tool or the like, and suppress a rise in the bearing temperature during operation.

Examples of the shape for the lubricant trap portions to be formed of in the guide surfaces of the column portions, i.e., the shape of gradually decreasing in axial width as extending radially outward in the axial centers include a generally triangular shape having an apex radially outward. It should be appreciated that the generally triangular shape is intended to include not only ones enclosed with three straight lines but also ones with curves. The apex shall also include ones where adjoining straight lines or curves are connected continuously. The lubricant trap portions are not limited to the generally triangular shape mentioned above, but may have any shape as long as they gradually decrease in axial width as extending radially outward in the axial centers.

Moreover, the lubricant trap portions of the foregoing configuration preferably have, at their radially innermost sides, an axial width which is set at 50% to 70% the axial length of the cylindrical rollers. This makes it possible to collect an optimum amount of lubricating oil to the axial centers. If the axial width at the radially innermost sides of the lubricant trap portions is smaller than 50% the axial length of the cylindrical rollers, the lubricating oil collected to the axial centers is insufficient in amount. If greater than 70%, the remaining areas of the guide surfaces of the pockets become too small with respect to the axial length of the cylindrical rollers, so that the areas may cause insufficient lubrication or abrasion of the guide surfaces due to short of oil films.

Furthermore, the lubricant trap portions of the foregoing configuration preferably have a maximum depth which is set at 3% to 10% the outside diameter of the cylindrical rollers. This facilitates holding the lubricating oil in the lubricant trap portions with reliability while the bearing is rotated at high speed. If these lubricant trap portions have a maximum depth below 3% the outside diameter of the cylindrical rollers, it becomes difficult for the lubricant trap portions to hold the lubricating oil while the bearing is rotated at high speed. Above 10%, it becomes difficult to pull mold parts out of the lubricant trap portions smoothly when releasing the retainer, if made of a resin, from the mold from radially inside to radially outside.

In addition, areas of the guide surfaces lying radially outside the lubricant trap portions of the foregoing configuration preferably have a radial dimension which is set at 5% to 15% the outside diameter of the cylindrical rollers. This makes the lubricant trap portions hold the lubricating oil with reliability. If these areas of the guide surfaces have a radial dimension smaller than 5% the outside diameter of the cylindrical rollers, it becomes difficult for the lubricant trap portions to hold the lubricating oil. If greater than 15%, it becomes difficult to secure the volumes of the lubricant trap portions, which lowers the capability of holding the lubricating oil.

### BRIEF DESCRIPTION OF THE DRAWINGS

FIG. 1 is a sectional view of a retainer according to an embodiment of the present invention, taken along the line A-A of FIG. 3;

FIG. 2 is a partial sectional view showing a single-row cylindrical roller bearing according to the embodiment of the present invention;

FIG. 3 is a plan view of the retainer of FIG. 1 as seen from radially outside;

FIG. 4 is a sectional view taken along the line B-B of FIG. 3;

FIG. 5 is a sectional view taken along the line C-C of FIG. 3;

FIG. 6 is a plan view of the retainer of FIG. 1 as seen from radially inside;

FIG. 7 is an enlarged sectional view showing essential parts of a guide surface of a column portion in FIG. 4;

FIG. 8 is a sectional view showing an example of a spindle unit of a machining tool; and

FIG. 9 is a partial sectional view showing a conventional example of a single-row cylindrical roller bearing.

### DETAILED DESCRIPTION OF THE PREFERRED EMBODIMENTS

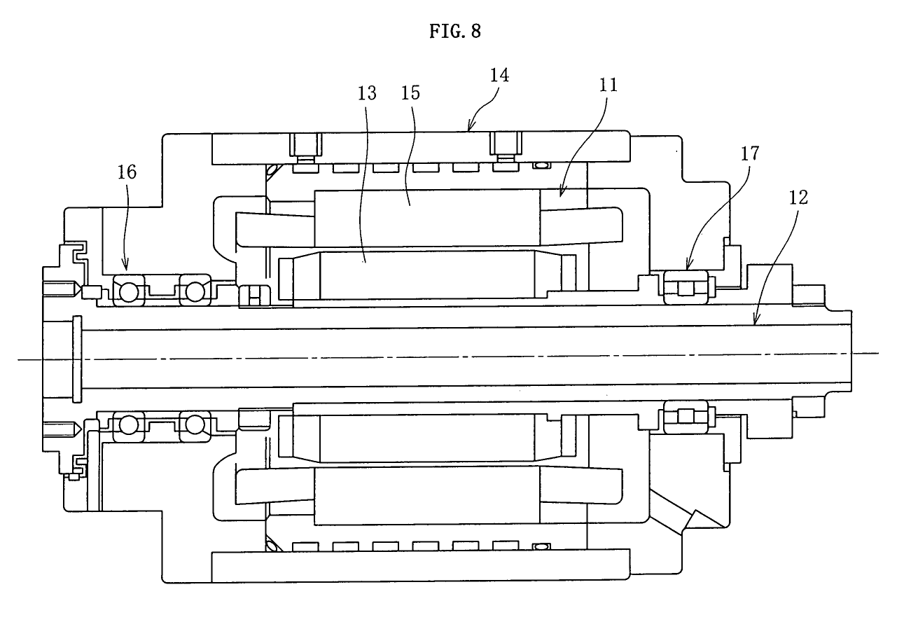

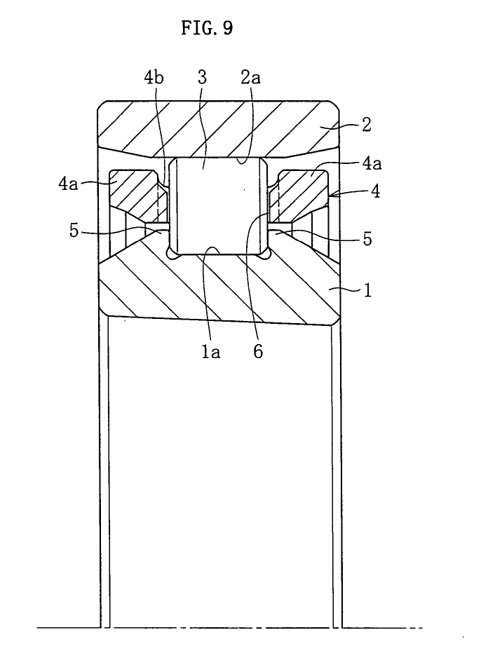

FIG. 8 shows an example of the structure of a spindle unit in a machining tool such as a machining center and a grinder. This spindle unit is one called built-in type, comprising a motor 11 arranged in the axial center of the spindle unit. The motor is composed of a rotor 13 arranged on the outer periphery of a spindle 12, and a stator 15 arranged on the inner periphery of a housing 14. When an electric current is applied to the stator 15, an excitation force occurs between the stator 15 and the rotor 13, and the spindle 12 is rotated by the excitation force. The spindle 12 is supported by rolling bearings arranged on the front side (tool side) and the rear side (non-tool side) across the motor 11, respectively, so that it is rotatable with respect to the housing 14. The rear side is typically given a structure for allowing axial displacements of the spindle 12 (free side) in order to absorb or relieve axial expansions of the spindle 12 ascribable to heat during operation. In this example, a composite angular ball bearing 16 (a pair of angular ball bearings) is used on the front side, and a single-row cylindrical roller bearing 17 is used on the rear side.

FIG. 2 shows a single-row cylindrical roller bearing of inner-ring flange type (N type), as an example of the cylindrical roller bearing 17 to be arranged on the rear side of the spindle unit of the foregoing machining tool (see FIG. 8). This cylindrical roller bearing is primarily composed of: an inner ring 21 having a raceway surface 21a on its outer periphery; an outer ring 22 having a raceway surface 22a on its inner periphery; a plurality of cylindrical rollers 23 rotatably arranged between the raceway surface 21a of the inner ring 21 and the raceway surface 22a of the outer ring 22; and a retainer 24 for retaining those cylindrical rollers 23 at predetermined intervals in the circumferential direction, being made of a resin, for example. Flange portions 25 for restraining axial movements of the cylindrical rollers 23 are formed on both sides of the outer periphery of the inner ring 21.

While this embodiment deals with the resin-made retainer 24, the retainer may be made of metal materials other than resin materials, including high stress brass castings and aluminum materials. Examples of the resin materials include polyether ether ketone (PEEK), PA 66, PA 46, and PPS mixed with 20% to 40% by weight of glass fibers or carbon fibers.

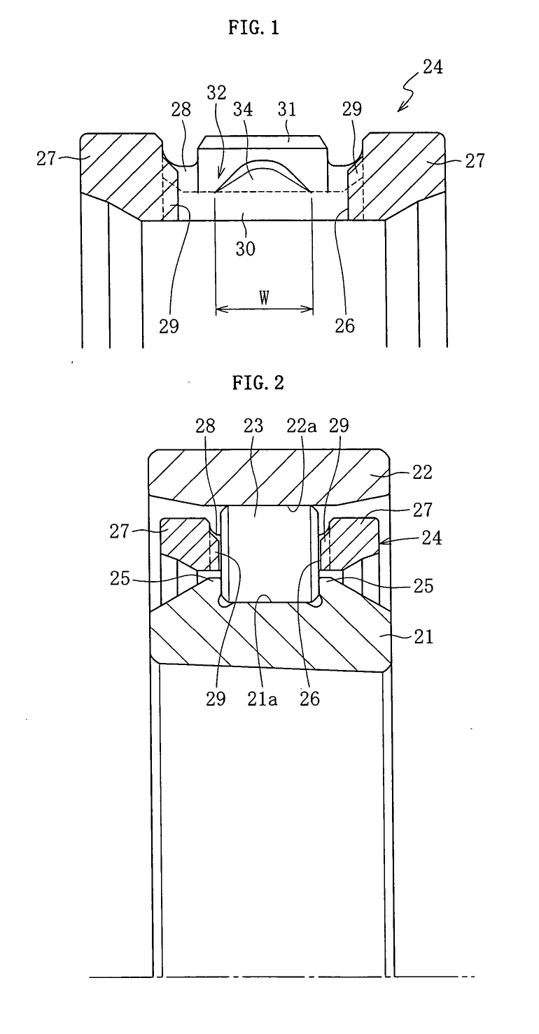

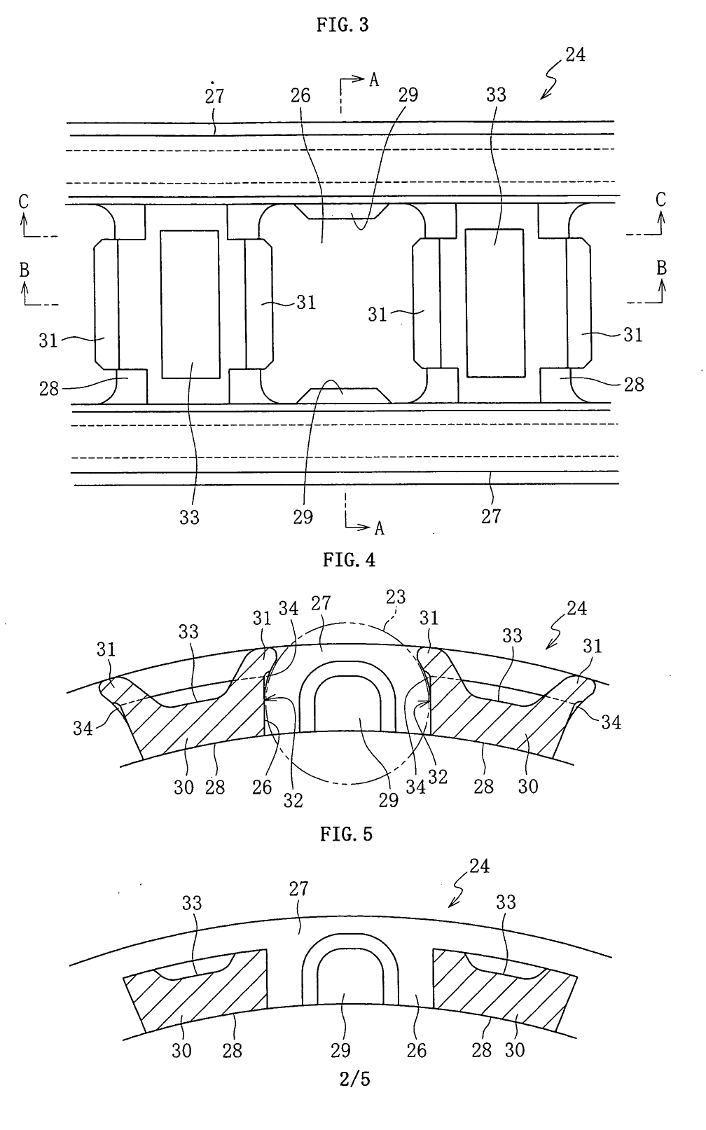

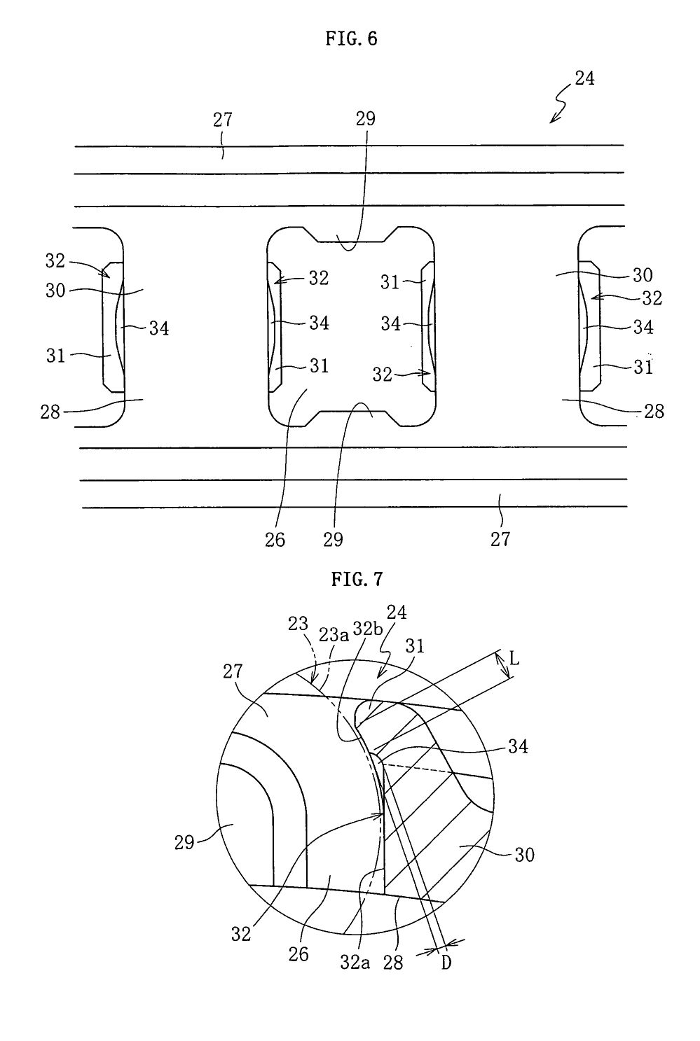

As shown in FIGS. 1 to 6, the retainer 24 comprises a pair of annular portions 27 opposed at a predetermined interval in the axial direction, and a plurality of column portions 28 for connecting the annular portions 27 to each other. Pockets 26 for accommodating the cylindrical rollers 23 are formed in the spaces surrounded by the opposed annular portions 27 and adjoining column portions 28. Contact surfaces 29, or slightly-recessed roller end guide areas, for guiding the ends of the cylindrical rollers 23 are formed on the inner sides of the annular portions 27 which constitute the circumferential walls of the pockets 26. Moreover, each column portion 28 is provided with a pair of tabs 31 extending in two branches from a base portion 30 in generally radial directions.

As shown enlarged in FIG. 7, the sides of the column portions 28 constituting the axial walls of the pockets 26 are each composed of a straight surface 32a on the radially inner side and an arc surface 32b on the radially outer side, which are smoothly continuous with each other. The straight surface 32a is mainly made of one of sides of the base portion 30, and the arc surface 32b is mainly made of the side of one of the tabs 31. The arc surface 32b traces an arc having a radius of curvature somewhat greater than that of rolling contact surfaces 23a of the cylindrical rollers 23. When the cylindrical rollers 23 move radially outward by a predetermined amount within and with respect to the pockets 26, they come into engagement with the arc surfaces 32b. This restrains the cylindrical rollers 23 from coming off radially outward. This retainer 24 is one whose rotation is guided by the cylindrical rollers 23, i.e., of so-called roller guide system. The straight surfaces 32a and the arc surfaces 32b make guide surfaces 32 for guiding the rolling contact surfaces 23a of the cylindrical rollers 23. Note that concave relieve portions 33 are formed between the other sides of the tabs 31.

In the retainer 24 of the foregoing configuration, lubricant trap portions 34 of concave shape, which gradually decrease in axial width as extending radially outward in the axial centers, are formed in the guide surfaces 32 of the column portions 28 for guiding the rolling contact surfaces 23a of the cylindrical rollers 23 opposed thereto in the circumferential direction of the pockets 26. In this embodiment, the lubricant trap portions 34 are formed in a generally triangular shape, having an apex radially outward, in the axial centers of the guide surfaces 32 from the straight surfaces 32a to the lower areas of the arc surfaces 32b.

As shown in FIG. 1, the shape of the lubricant trap portions 34 of the guide surfaces 32, i.e., the generally triangular shape having an apex radially outward is such that two sides are connected by a smooth continuous curve with the axial width W at the radially innermost side as the base. It should be appreciated that while this embodiment shows the lubricant trap portions 34 of generally triangular shape, the lubricant trap portions 34 are not limited to the generally triangular shape but may have other shapes as long as they gradually decrease in axial width as extending radially outward in the axial centers.

The lubricating oil held in or supplied to the pockets 26 of the retainer 24 is taken into the lubricant trap portions 34 of concave shape formed in the guide surfaces 32 of the pockets 26, and moves radially outward due to a centrifugal force during operation. Here, since the lubricant trap portions 34 described above have the generally triangular shape such that they gradually decrease in axial width as extending radially outward in the axial centers, the lubricating oil taken into the lubricant trap portions 34 is collected to the axial centers while moving radially outward. As a result, the lubricating oil can be supplied to the axial centers of the cylindrical rollers 23 easily where lubrication is the most difficult.

The axial width W at the radially innermost sides of the foregoing lubricant trap portions 34 is set at 50% to 70% the axial length of the cylindrical rollers 23 as shown in FIG. 1. This makes it possible to collect an optimum amount of lubricating oil to the axial centers. If the radially innermost sides of the lubricant trap portions 34 have an axial width W smaller than 50% the axial length of the cylindrical roller 23, the lubricating oil collected to the axial centers is insufficient in amount. If greater than 70%, the remaining areas of the guide surfaces of the pockets 26 become too small with respect to the axial length of the cylindrical rollers 23, so that the areas cause insufficient lubrication or abrasion of the guide surfaces 32 due to short of oil films.

Moreover, the maximum depth D of these lubricant trap portions 34 is set at 3% to 10% the outside diameter of the cylindrical rollers 23 as shown in FIG. 7. This facilitates holding the lubricating oil in the lubricant trap portions 34 with reliability when the bearing is rotated at high speed. If the lubricant trap portions 34 have a maximum width D below 3% the outside diameter of the cylindrical rollers 23, it becomes difficult for the lubricant trap portions 34 to hold the lubricating oil while the bearing is rotated at high speed. Above 10%, it becomes difficult to pull mold parts out of the lubricant trap portions 34 smoothly when releasing the retainer 24, if made of a resin, from the mold from radially inside to radially outside.

Furthermore, the areas of the guide surfaces lying radially outside the lubricant trap portions 34, i.e., the upper areas of the arc surfaces 32b of the guide surfaces 32 have a radial dimension L which is set at 5% to 15% the outside diameter of the cylindrical rollers 23 as shown in FIG. 7. This makes the lubricant trap portions 34 hold the lubricating oil with reliability. If the upper areas of the arc surfaces 32b have a radial dimension L smaller than 5% the outside diameter of the cylindrical rollers 23, it becomes difficult for the lubricant trap portions 34 to hold the lubricating oil. If greater than 15%, it becomes difficult to secure the volumes of the lubricant trap portions 34, which lowers the capability of holding the lubricating oil.

For example, if the inner ring 21 has the flanges 25, the tabs 31 for preventing the cylindrical rollers 23 from coming off and for the cylindrical rollers 23 and the pockets 26 of the retainer 24 to position radially are formed on the radially outer side of the retainer 24. In a mold, the tabs 31 are shaped smaller than the pocket 26. When the pocket mold is pulled out radially outward by force, the tabs 31 make elastic deformation to allow the force pulling. Since the cylindrical rollers 23 are loaded from radially outside, the tabs 31 also make elastic deformation when the cylindrical rollers 23 pass. To facilitate this elastic deformation of the tabs 31, the relief portions 33 are formed in the centers of the column portions 28.

As shown in FIG. 8, the cylindrical roller bearing of this embodiment is mounted so that the inner ring 21 is fitted to the outer periphery of the spindle 12, and the outer ring 22 is fitted into the inner periphery of the housing 14. The radial internal clearance for operation is set to a negative clearance (a preloaded state). The interior of the bearing is lubricated by such a lubrication method as air oil lubrication, oil mist lubrication, jet lubrication, and grease lubrication. When the spindle 12 is rotationally driven at high speed by the motor 11 which is built in the spindle unit, the spindle 12 is supported by the angular ball bearings 16 on the front side and the cylindrical roller bearing 17 on the rear side so that it is rotatable with respect to the housing 14. Moreover, when the spindle 12 makes thermal expansion in the axial direction due to a temperature rise during operation, the amount of axial thermal expansion is absorbed or relieved by a slide displacement between the outer ring 22 and the cylindrical rollers 23 of the cylindrical roller bearing 17.

While the foregoing embodiment has dealt with the case where the column portions 28 of the pockets 26 are each provided with a single pair of tabs 31 in the axial centers, the present invention is not limited thereto but may be applied to a structure in which a plurality (for example, two) of pairs of tabs are axially arranged on each of the column portions of the pockets. In this case, two lubricant trap portions may be axially arranged in each of the guide surfaces of the pockets. Even in the foregoing case of a single pair of tabs, two or more lubricant trap portions may be arranged in the axial direction.

1. A cylindrical roller bearing comprising: an inner ring having a raceway surface on an outer periphery thereof; an outer ring having a raceway surface on an inner periphery thereof; a plurality of cylindrical rollers rotatably interposed between the raceway surface of the inner ring and the raceway surface of the outer ring; and a retainer for retaining the cylindrical rollers at predetermined intervals in a circumferential direction, wherein
the retainer is composed of a pair of annular portions and a plurality of column portions for connecting the annular portions to each other,
pockets for accommodating the cylindrical rollers are formed in spaces surrounded by the opposed annular portions and adjoining column portions, and
lubricant trap portions are formed in guide surfaces of the column portions for guiding rolling contact surfaces of the cylindrical rollers opposed thereto in the circumferential direction of the pockets, the lubricant trap portions gradually decreasing in axial width as extending radially outward in axial centers.

2. The cylindrical roller bearing according to claim 1, wherein the lubricant trap portions are formed in the guide surfaces of the column portions in a generally triangular shape having an apex radially outward.

3. The cylindrical roller bearing according to claim 1, wherein the lubricant trap portions have, at their radially innermost sides, an axial width which is set at 50% to 70% an axial length of the cylindrical rollers.

4. The cylindrical roller bearing according to claim 1, wherein the lubricant trap portions have a maximum depth which is set at 3% to 10% an outside diameter of the cylindrical rollers.

5. The cylindrical roller bearing according to claim 1, wherein areas of the guide surfaces lying radially outside the lubricant trap portions have a radial dimension which is set at 5% to 15% an outside diameter of the cylindrical rollers.

6. A retainer for a cylindrical roller bearing, comprising a pair of annular portions and a plurality of column portions for connecting the annular portions to each other, and pockets for accommodating cylindrical rollers being formed in spaces surrounded by the opposed annular portions and adjoining column portions, wherein lubricant trap portions are formed in guide surfaces of the column portions for guiding rolling contact surfaces of the cylindrical rollers opposed thereto in the circumferential direction of the pockets, the lubricant trap portions gradually decreasing in axial width as extending radially outward in axial centers.

7. The retainer for a cylindrical roller bearing according to claim 6, wherein the lubricant trap portions are formed in the guide surfaces of the column portions in a generally triangular shape having an apex radially outward.

8. The retainer for a cylindrical roller bearing according to claim 6, wherein the lubricant trap portions have, at their radially innermost sides, an axial width which is set at 50% to 70% an axial length of the cylindrical rollers.

9. The retainer for a cylindrical roller bearing according to claim 6, wherein the lubricant trap portions have a maximum depth which is set at 3% to 10% an outside diameter of the cylindrical rollers.

10. The retainer for a cylindrical roller bearing according to claim 6, wherein areas of the guide surfaces lying radially outside the lubricant trap portions have a radial dimension which is set at 5% to 15% an outside diameter of the cylindrical rollers.

11. The cylindrical roller bearing according to claim 2, wherein the lubricant trap portions have, at their radially innermost sides, an axial width which is set at 50% to 70% an axial length of the cylindrical rollers.

12. The cylindrical roller bearing according to claim 2, wherein the lubricant trap portions have a maximum depth which is set at 3% to 10% an outside diameter of the cylindrical rollers.

13. The cylindrical roller bearing according to claim 2, wherein areas of the guide surfaces lying radially outside the lubricant trap portions have a radial dimension which is set at 5% to 15% an outside diameter of the cylindrical rollers.

14. The retainer for a cylindrical roller bearing according to claim 7, wherein the lubricant trap portions have, at their radially innermost sides, an axial width which is set at 50% to 70% an axial length of the cylindrical rollers.

15. The retainer for a cylindrical roller bearing according to claim 7, wherein the lubricant trap portions have a maximum depth which is set at 3% to 10% an outside diameter of the cylindrical rollers.

16. The retainer for a cylindrical roller bearing according to claim 7, wherein areas of the guide surfaces lying radially outside the lubricant trap portions have a radial dimension which is set at 5% to 15% an outside diameter of the cylindrical rollers.
